(19) United States
(12) Patent Application Publication
(10) Pub. No.: US 2012/0045184 A1
(43) Pub. Date: Feb. 23, 2012

(54) INSTALLATION ASSEMBLY FOR SPLICING OPTICAL FIBERS AND METHOD FOR SPLICING OPTICAL FIBERS

(75) Inventors: Wayne Fan, Shanghai (CN); Eric Wang, Shanghai (CN)

(73) Assignee: Raychem Shanghai Cable Accessories Ltd., Shanghai (CN)

(21) Appl. No.: 13/266,719

(22) PCT Filed: Apr. 23, 2010
(86) PCT No.: PCT/IB2010/051803

§ 371 Date: Oct. 27, 2011

(30) Foreign Application Priority Data
Apr. 28, 2009 (CN) 200910050536.3

(51) Int. Cl. G02B 6/255; B23P 11/00

(52) U.S. Cl. 385/95; 29/428

(57) ABSTRACT

An installation assembly for connecting an optical fiber cable and an optical fiber connector is disclosed. The installation assembly comprises an fixing member adapted to fixing the optical fiber cable; a guiding member, the fixing member is movably provided in the guiding member so as to guide a bare fiber of the optical fiber cable into the optical fiber connector and thus to bring the bare fiber to be in effective contact with an inline optical fiber in the optical fiber connector; and a splicing member, the splicing member is fitted with the guiding member and the fixing member, and splices the bare fiber of the optical fiber cable and the inline optical fiber in the optical fiber connector. The above solution provides a simple installation assembly which is capable of splicing optical fibers with easy and simple operations at site. The above solution can be applied to splice various types of optical fibers. Correspondingly, the present invention also provides a method for splicing optical fibers.

### FIELD OF THE INVENTION

This present invention relates to a filed of optical fiber wiring, particularly to a simple installation tool capable of splicing optical fibers at site with easy and simple operations, and to a method for splicing optical fibers by means of the simple installation tool.

### BACKGROUND OF THE INVENTION

Generally, a Field Installable Connector is used to perform field splicing of optical fibers. At present, Field Installable Connectors available in the market have to be used together with special installation tools, such as LightCrimp Plus SC Simplex Connector Kits, during performing the field splicing of the optical fibers. Specifically, in the process of the field splicing of the optical fibers and field making of a connector, such installation tools are needed for a series of operations, such as fixing of an object connector, locating of an optical fiber cable, splicing of the optical fibers. Therefore, in order to achieve the field splicing of the optical fibers and the field making of the connector, an operator has to carry about the installation tools, which is much inconvenient to the operator.

Further, the operation of the installation tools is relatively complicated due to the specialty thereof; however, the installation tools must be used in the current field wiring of optical fibers, thus, a relative high installation cost is also resulted.

At the same time, the application of 8-shaped optical fiber cables (FIG. 8 optical fiber cables) is becoming more and more popular in the current optical fiber field, especially in installing optical network units for home consumers or office consumers, i.e. fiber to the home (FTTH). However, such current installation tools is restrictedly adapted to splice circular optical fiber cables, and thus is not suitable for splicing 8-shaped optical fiber cables.

### SUMMARY OF THE INVENTION

In view of the above technical problems mentioned in the Background, the invention is directed to solve at least one aspect of the aforesaid problems and defects existing in the prior arts.

At least one object of the present invention is to provide a simple installation assembly which is capable of splicing optical fibers with easy and simple operations at site, and thus achieving a tool-less field splicing of optical fibers.

A further object of the present invention is to provide a simple installation assembly which can be applied to various types of optical fibers.

At least one solution of the present invention is as follows: an installation assembly for connecting an optical fiber cable and an optical fiber connector, comprising: a fixing member adapted to fixing the optical fiber cable; a guiding member, the fixing member is movably provided in the guiding member so as to guide a bare fiber of the optical fiber cable into the optical fiber connector and to bring the bare fiber into effective contact with an inline optical fiber in the optical fiber connector; and a splicing member, the splicing member is fitted with the guiding member and the fixing member, and splices the bare fiber of the optical fiber cable and the inline optical fiber in the optical fiber connector.

Further, the installation assembly further comprises a fine tuning structure provided between the fixing member and the guiding member, the fine tuning structure adjusts the lead-in amount of the bare fiber of the optical fiber cable in the optical fiber connector by adjusting the displacement of the fixing member relative to the guiding member.

Specifically, the fine tuning structure comprises: first guiding teeth formed on the fixing member; and second guiding teeth formed on the guiding member, wherein through the engagement between the first guiding teeth and the second guiding teeth, the displacement and locating of the fixing member in the guiding member is achieved, thus the lead-in amount of the bare fiber of the optical fiber cable in the optical fiber connector is controlled, and wherein tooth pitch of the first guiding teeth and that of the second guiding teeth are determined based on a maximum flexible radius of the bare fiber of the optical fiber cable. Further, the optical fiber connector comprises an optical fiber fixing device, the splicing member acts on the optical fiber fixing device and fixes the bare fiber in the optical fiber connector via the optical fiber fixing device so that the bare fiber and the inline optical fiber are spliced.

According to one specific embodiment, the splicing member comprises a housing for locating the optical fiber connector and the guiding member; and a handle that is provided on the housing and movable with respect to the housing, wherein the handle is provided on the housing in manner of thread screwing, and wherein the bare fiber is fixed in the optical fiber connector by a front end of the handle in a manner that the front end presses the optical fiber fixing device. Preferably, the optical fiber fixing device is made of solid adhesive.

According to one specific embodiment, the fixing member comprises a receiving chamber adapted to receive the optical fiber cable; and fixing teeth formed in the receiving chamber and adapted to fix the optical fiber cable.

According to one specific embodiment, the guiding member further comprises a cover that covers the guiding member from outside and strengthens the locating of the fixing member in the guiding member, meanwhile the cover connects the fixing member and the guiding member including the optical fiber cable fixed therein to form a whole connector.

According to one specific embodiment of the present invention, the fixing member and the optical fiber connector are located at both ends of the guiding member respectively upon installation. The fixing member may be detachably connected with the guiding member, while the optical fiber connector may connect the guiding member in manner of interference fitting. The splicing member may be a disposable optical fiber splicing tool which can be discarded after one or more times of connection between the optical fiber cable and the optical fiber connector.

Preferably, the fixing member, the guiding member and the splicing member are made of plastic material.

The present invention also provides a method for splicing optical fibers by using the above installation assembly. Specifically, the method for splicing optical fibers comprises the steps of: providing a fixing member and fixing an optical fiber cable in the fixing member; providing a guiding member, and connecting an optical fiber connector and the fixing member having the optical fiber cable fixed therein to both ends of the guiding member respectively; pushing the fixing member along the guiding member and putting a bare fiber of the optical fiber cable into the optical fiber connector until the optical fiber cable bends slightly so that the bare fiber of the optical fiber cable is in effective contact with an inline optical fiber in the optical fiber connector; providing a splicing member to press an optical fiber fixing device in the optical fiber connector and thus to fix the bare fiber within the optical fiber connector, so that an effective splicing between the bare fiber of the optical fiber cable and the inline optical fiber in the optical fiber connector is achieved.

According to one specific embodiment of the present invention, in the above method, lead-in amount of the bare fiber of the optical fiber cable in the optical fiber connector is adjusted through adjusting displacement of the fixing member relative to the guiding member by means of a fine tuning structure. The bare fiber may be in line with the inline optical fiber upon installation, and the optical fiber connector may be connected to the guiding member in manner of interference fitting. In addition, the splicing member may be operated in manner of thread screwing.

According to one specific embodiment of the present application, after connecting the bare fiber and the inline optical fiber, a cover is provided to cover the guiding member from outside and strengthen the locating of the fixing member in the guiding member, wherein the cover connects the fixing member and the guiding member having the optical fiber cable fixed therein to form a whole connector.

The present invention provides a simple installation assembly which is capable of splicing optical fibers with easy and simple operations at site. The above solution can also be applied to splice various types of optical fibers. In addition, the present invention provides a method for splicing optical fibers by using the above installation assembly.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 shows an installation assembly according to one exemplary embodiment of the present invention, and shows schematically a state in which the splicing of optical fibers is performed by means of the installation assembly;

FIG. 2 is a sectional view of FIG. 1 which shows schematically the inner structures of various components of the installation assembly and a state in which the optical fibers are spliced preliminarily;

FIG. 3 is a schematic structure view of a guiding member and an optical fiber connector of the installation assembly according to the exemplary embodiment of the invention, which shows a state in which the guiding member is connected with the optical fiber connector;

FIG. 4 is a schematic structure view of a fixing member of the installation assembly according to the exemplary embodiment of the invention, which shows schematically a state in which an optical fiber cable is fixed in the fixing member;

FIG. 5 is a schematic structure view of an fixing member of the installation assembly according to the exemplary embodiment of the invention, which shows schematically another state in which an optical fiber cable is also fixed in the fixing member;

FIG. 6 shows a state after the splicing of optical fibers is completed in the exemplary embodiment of the invention by using the installation assembly of the present invention, in which the splicing member in the installation assembly is removed while the fixing member and the guiding member in the installation assembly become constituent portions of a new connector for butt-jointing the optical fiber connector; and

FIG. 7 shows a another state after the splicing of optical fibers is completed in one further exemplary embodiment of the invention by using the installation assembly of the invention, in which the splicing member in the installation assembly is removed while the fixing member and the guiding member in the installation assembly are covered with a cover so that a whole connector for butt-jointing the optical fiber connector is formed.

### DESCRIPTION OF THE PREFERRED EMBODIMENTS

Exemplary embodiments of the present disclosure will be described hereinafter in detail with reference to the attached drawings. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

The scope of the present invention will in no way be limited to the simply schematic views of the drawings, the number of constituting components, the materials thereof, the shapes thereof, the relative arrangement thereof, etc., and are disclosed simply as an example of an embodiment.

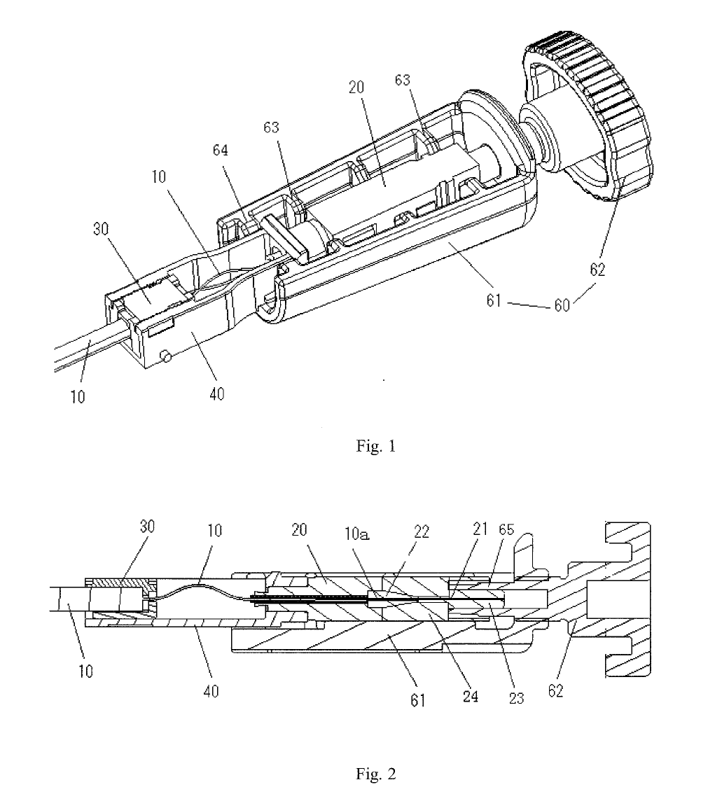

Referring to FIG. 1, the present invention provides a simple installation assembly for connecting an optical fiber cable 10 to an optical fiber connector 20. FIG. 1 shows an installation assembly according to one exemplary embodiment of the present invention. According to the present invention, the installation assembly mainly comprises a fixing member 30, a guiding member 40 and a splicing member 60. Further, FIG. 1 shows the optical fiber cable 10 and the optical fiber connector 20 which are installation objects of the installation assembly of the present invention.

In the present invention, the optical fiber cable 10 as an installation object may be various types of optical fiber cables, comprising but not limited to, a circular optical cable, and an 8-shaped optical fiber cable the application which is more and more widely used. Specifically, as shown in FIG. 2, the optical fiber cable 10 according to the embodiment comprises, but not limited to, a bare fiber 10a, a cladding layer surrounding the bare fiber 10a, and an outer coating layer at the outermost; the optical fiber connector 20 may be used in optical fiber wiring, especially be of any type of optical fiber connector which is used in installing optical network units for home consumers or office consumers, i.e. fiber to the home (FTTH), an in the embodiment, as shown in FIG. 2, the optical fiber connector 20 substantially comprises a connector housing, an inline optical fiber 21 embedded in the connector housing, and an optical fiber fixing device 22 for fixing the inline optical fiber 21.

According to the present invention, as shown in FIG. 1 and FIG. 2, an installation assembly for connecting the optical fiber cable 10 and the optical fiber connector 20, comprising: the fixing member 30 adapted to fixing the optical fiber cable 10; the guiding member 40, in which the fixing member 30 is movably provided so as to guide the bare fiber 10a of the optical fiber cable 10 into the optical fiber connector 20 and bring the bare fiber 10a to be in effective contact with the inline optical fiber 21 in the optical fiber connector 20; and the splicing member 60, the splicing member 60 is fitted with the guiding member 40 and the fixing member 30, and splices the bare fiber 10a of the optical fiber cable 10 and the inline optical fiber 21 in the optical fiber connector 20.

It should be noted that the splicing member of the installation assembly according to the present invention is in the form of a disposable mechanical part which is simple and practical, so that a tool-less field splicing of optical fibers is achieved. Preferably, the fixing member 30, the guiding member 40 and the splicing member 60 are made of plastic material.

According to the exemplary embodiment of the present invention, as shown in FIGS. 4 and 5, the fixing member 30 comprises a receiving chamber 31 adapted to receive the optical fiber cable 10; and fixing teeth 32 formed in the receiving chamber 31 and adapted to fix the optical fiber cable 10. Specifically, when the optical fiber cable 10 is put in the receiving chamber 31, the fixing teeth 32 of the fixing member 30 bite the outer coating layer of the optical fiber cable 10 so as to fix the optical fiber cable 10. It should be noted that in the embodiment, the fixing teeth 32 of the fixing member 30 can provide an axial bite force of at least 30 N acting on the optical fiber cable 10 fixed in the receiving chamber 31, so that an excellent fixing effect is obtained. However, in other embodiments, the fixing member 30 may have other structures which can fix the optical fiber cable 10 effectively.

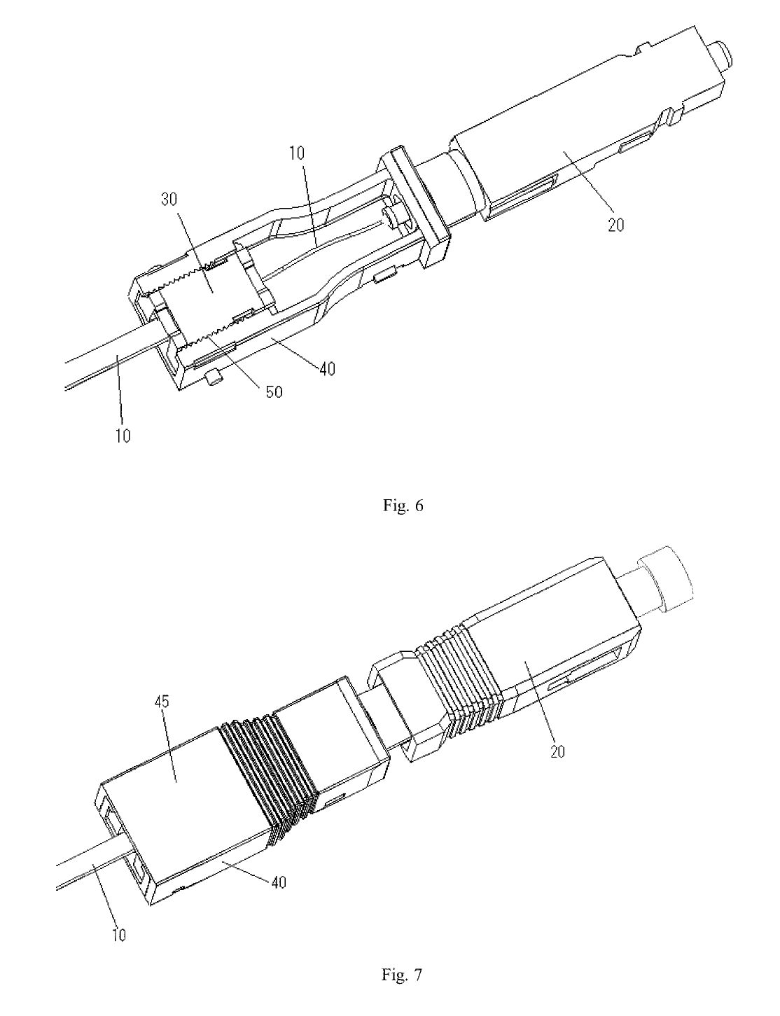

Based on the invention, as shown in FIG. 6, the installation assembly further comprises a fine tuning structure 50 provided between the fixing member 30 and the guiding member 40, the fine tuning structure 50 adjusts lead-in amount of the bare fiber 10a of the optical fiber cable 10 in the optical fiber connector 20 by adjusting displacement of the fixing member 30 relative to the guiding member 40. According to the exemplary embodiment, as shown in FIGS. 1-6, the fine tuning structure 50 comprises: first guiding teeth 51 formed on the fixing member 30; and second guiding teeth 52 formed on the guiding member 40, wherein through engagement between the first guiding teeth 51 and the second guiding teeth 52, the displacement and locating of the fixing member 30 in the guiding member 40 is achieved, thus the lead-in amount of the bare fiber 10a of the optical fiber cable 10 in the optical fiber connector 20 is controlled. Specifically, tooth pitch of the first guiding teeth 51 and the second guiding teeth 52 is determined based on a maximum flexible radius of the bare fiber 10a of the optical fiber cable 10. However, in another embodiment, the fine tuning structure 50 of the present invention may be of any other structure or in any other form which can achieve optional locating of the fixing member 30 having the optical fiber cable therein relative to the guiding member 40.

According to the present invention, as shown in FIGS. 1-2, the splicing member 60 comprises a housing 61 for locating the optical fiber connector 20 and the guiding member 40; and a handle 62 which is provided on the housing 61 and movable with respect to the housing 61, wherein the handle 62 is provided on the housing 61 in manner of thread screwing. As shown in FIG. 1, a plurality of ribs 63 are provided at the inner side of the housing 61, the ribs 63 are adapted to be engaged with the outer housing of the optical fiber connector 20 so as to locate the optical fiber connector 20 when the optical fiber connector 20 is detachably inserted into the housing 61. As shown in FIG. 1, ribs 64 for locating the guiding member 40 are also provided inside the housing 61. It should be noted that any other structure which can locate the optical fiber connector 20 and the guiding member 40 may be provided inside the housing 61.

As shown in FIG. 2, a circular wall 65 is formed at the front end of the handle 62, the optical fiber connector 20 has a guiding portion 23 for receiving a inline optical fiber 21 therein and a pressure conduct portion 24, wherein the guiding portion 23 is adapted to be fit in a hollow space formed by the circular wall 65, and the circular wall 65 will be in contact with the pressure conduct portion 24 and will apply pressure to it by thread screwing of the handle 62.

According to the invention, the splicing member 60 may be a disposable optical fiber splicing tool which can be discarded after one or more times of junction between the optical fiber cable 10 and the optical fiber connector 20. In other words, in the installation assembly of the invention, the splicing member 60 is a throwaway mechanical part.

In the invention, the optical fiber connector 20 serving as a connecting object comprises therein an optical fiber fixing device 22, wherein the splicing member 60 acts on the optical fiber fixing device 22 and fixes the bare fiber 10a in the optical fiber connector 20 via the optical fiber fixing device 22 so that the bare fiber 10a and the inline optical fiber 21 are spliced.

The bare fiber 10a may be fixed in the optical fiber connector 20 by a front end of the handle 60 in a manner that the front end presses the optical fiber fixing device 22. According to the embodiment of the present invention, the optical fiber fixing device 22 is preferably made of a solid adhesive which can be solidified by itself after being pressed. Specifically, in the present embodiment and as shown in FIG. 2, the front end of the handle 62, that is, the front end of the circular wall 65, is in contact with the pressure conduct portion 24 of the optical fiber connector 20, and applies pressure to the pressure conduct portion 24 by thread screwing of the handle 62, then the pressure is conducted from the pressure conduct portion 24 to the solid adhesive 22, thus, the solid adhesive 22 is deformed after being pressed by the front end of the handle 62, thus the solid adhesive 22 is solidified at a position at which the bare fiber 10a is in contact with the inline optical fiber 21, and thus the bare fiber 10a and the inline optical fiber 21 are fixed effectively, in this way, a stable splicing between the bare fiber 10a of the optical fiber cable 10 and the inline optical cable 21 in the optical fiber connector 20 is ensured.

Further, in the installation assembly of the present invention, the guiding member 40 further comprises a cover 45, as shown in FIGS. 6-7, the cover 45 covers the guiding member 40 from outside and strengthens the locating of the fixing member 30 in the guiding member 40, wherein the cover 45 connects the fixing member 30 the guiding member 40 having the optical fiber cable 10 fixed therein to form a whole connector. Thus, the optical fiber cable 10 and the optical fiber connector 20 are spliced effectively. According to one exemplary embodiment of the present invention, upon installation, the fixing member 30 and the optical fiber connector 20 are located at both ends of the guiding member 40 respectively. According to one exemplary embodiment of the present invention, the fixing member 30 is detachably connected with the guiding member 40. According to a further embodiment, the optical fiber connector 20 connects the guiding member 40 in manner of interference fitting.

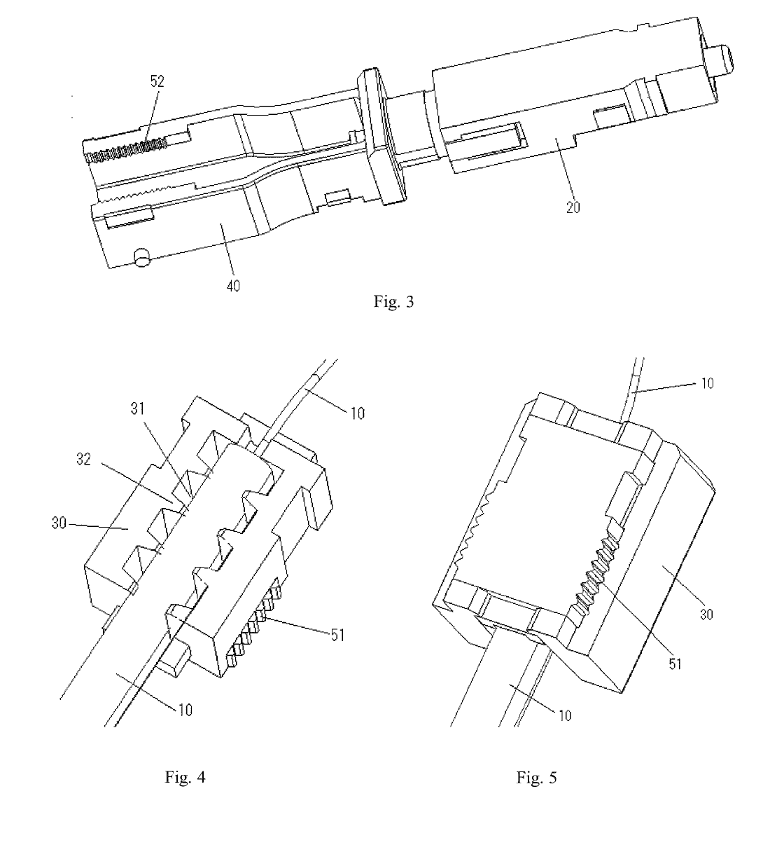

The installation assembly of the present invention has been described above with respect to the exemplary embodiments; next, a method for splicing optical fibers will be described, taken in conjunction with the installation assembly mentioned above. Specifically, as shown in FIGS. 3-7, the method for splicing optical fibers at least comprises the steps of:

1) providing the fixing member 30 and fixing the optical fiber cable 10 in the fixing member;

2) providing the guiding member 40, and connecting the optical fiber connector 20 and the fixing member 30 having the optical fiber cable 10 fixed therein to both ends of the guiding member 40 respectively;

3) pushing the fixing member 30 along the guiding member 40 and putting the bare fiber 10a of the optical fiber cable 10 into the optical fiber connector 20 until the optical fiber cable 10 bends slightly so that the bare fiber 10a of the optical fiber cable 10 is in effective contact with the inline optical fiber 21 in the optical fiber connector 20;

4) providing the splicing member 60 to press the optical fiber fixing device 22 in the optical fiber connector 20 and thus to fix the bare fiber 10a within the optical fiber connector 20, so that an effective splicing between the bare fiber 10a of the optical fiber cable 10 and the inline optical fiber 21 in the optical fiber connector 20 is achieved.

Specifically, according to the exemplary embodiment of the present invention, in the above method for splicing optical fibers, first, as shown in FIGS. 4-5, the optical fiber cable 10, for example, the 8-shaped optical fiber, to be connected is put in the receiving chamber 31 of the fixing member 30, and is fixed by the fixing teeth 32 formed in the receiving chamber 31, then a protective cover is covered on the receiving chamber 31, wherein the optical fiber cable 10 to be connected which has been fixed in this manner can bear an axial force of at least 30 N after fixation, thus, unintentional pulling the optical fiber cable 10 out of the fixing member 30 is avoided effectively. Moreover, as shown in FIG. 3, the optical fiber connector 20 is connected to the guiding member 40 serving as a connecting object, in manner of interference fitting.

Then, the fixing member 30 is put in the guiding member 40, and the bare fiber 10a of the optical fiber cable 10 is inserted into an inlet of the optical fiber connector 20, and then the fixing member 30 is pushed along the guiding member 40 so as to insert the bare fiber 10a of the optical fiber cable 10 into the optical fiber connector 20 until the optical fiber cable 10 exposed outside the optical fiber connector 20 bends slightly, at this point, the bare fiber 10a of the optical fiber cable 10 is in preliminary contact with the inline optical fiber 21 of the optical fiber connector 20. During the above operation, the bare fiber 10a is in line with the inline optical fiber 21.

According to the exemplary embodiment of the present invention, in the step 3) of the method, displacement of the bare fiber 10a of the optical fiber cable 10 in the optical fiber connector 20 is adjusted through adjusting displacement of the fixing member 30 relative to the guiding member 40 by means of the fine tuning structure 50 provided between the fixing member 30 and the guiding member 40. Specifically, the movement and locating of the fixing member 30 in the guiding member 40 is achieved through biting engagement between the second guiding teeth 52 of the guiding member 40 and the first guiding teeth 51 of the fixing member 30.

According to the exemplary embodiment, the optical fiber fixing device in the step 3) of the method is preferably a solid adhesive. In addition, according to the exemplary embodiment of the invention, in the step 3) of the method, the splicing member 60 is operated in manner of thread screwing. Specifically, as shown in FIGS. 1-2, the front end of the handle 62, that is, the front end of the circular wall 65, is in contact with the pressure conduct portion 24 of the optical fiber connector 20, then the handle 62 of the splicing member 60 rotates relative to the housing 61 in manner of thread screwing, thus, the front end of the handle 62 applies pressure to the pressure conduct portion 24, and then the pressure is conducted from the pressure conduct portion 24 to the solid adhesive 22, in this manner, the front end of the handle 62 presses the solid adhesive 22 in the optical fiber connector 20, so that the splicing of the bare fiber 10a of the optical fiber cable 10 and the inline optical fiber 21 received in the optical fiber connector 20 is achieved in the optical fiber connector 20.

According to the exemplary embodiment of the present invention, after the splicing member 60 has pressed the solid adhesive 22 in the process of splicing the optical fibers, the splicing member 60 may be detached from the optical fiber connector 20 for another use. That is, the splicing member 60 is a disposable optical fiber splicing tool which can be discarded after one or more times of connection between the optical fiber cable 10 and the optical fiber connector 20.

According to the exemplary embodiment of the present invention, as shown in FIGS. 6-7, the above method for splicing optical fibers further comprises the following step: providing a cover 45, after splicing the bare fiber and the inline optical fiber, the cover 45 covers the guiding member 40 from outside and strengthens the locating of the fixing member 30 in the guiding member 40, wherein the cover 45 connects the fixing member 30 and the guiding member 40 having the optical fiber cable 10 fixed therein to form a whole connector.

Concerning the above, the invention provides a simple installation assembly which is capable of splicing optical fibers with easy and simple operations at site. Further, the installation assembly can be applied to splice various types of optical fibers. Correspondingly, the present invention also provides a method for splicing optical fibers.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An installation assembly for connecting an optical fiber cable and an optical fiber connector, comprising:
a fixing member adapted to fixing the optical fiber cable;
a guiding member, the fixing member is movably provided in the guiding member so as to guide a bare fiber of the optical fiber cable into the optical fiber connector, and to bring the bare fiber to be in effective contact with an inline optical fiber in the optical fiber connector; and
a splicing member the splicing member is fitted with the guiding member and the fixing member, and splices the bare fiber of the optical fiber cable and the inline optical fiber in the optical fiber connector.

2. The installation assembly of claim 1, further comprising:
a fine tuning structure provided between the fixing member and the guiding member, the fine tuning structure adjusts lead-in amount of the bare fiber of the optical fiber cable in the optical fiber connector by adjusting displacement of the fixing member relative to the guiding member.

3. The installation assembly of claim 2, wherein the fine tuning structure comprises:
first guiding teeth formed on the fixing member; and
second guiding teeth formed on the guiding member, wherein through engagement between the first guiding teeth and the second guiding teeth, the displacement and locating of the fixing member in the guiding member is achieved, thus the lead-in amount of the bare fiber of the optical fiber cable in the optical fiber connector is controlled.

4. The installation assembly of claim 3, wherein tooth pitch of the first guiding teeth and that of the second guiding teeth are determined based on a maximum flexible radius of the bare fiber of the optical fiber cable.

5. The installation assembly of claim 1, wherein the optical fiber connector comprises an optical fiber fixing device, the splicing member acts on the optical fiber fixing device and fixes the bare fiber in the optical fiber connector via the optical fiber fixing device so that the bare fiber and the inline optical fiber are spliced.

6. The installation assembly of claim 5, wherein the splicing member comprises:
a housing for locating the optical fiber connector and the guiding member; and
a handle which is provided on the housing and movable with respect to the housing.

7. The installation assembly of claim 6, wherein the handle is provided on the housing in manner of thread screwing.

8. The installation assembly of claim 7, wherein the bare fiber is fixed in the optical fiber connector by a front end of the handle in a manner that the front end presses the optical fiber fixing device.

9. The installation assembly of claim 8, wherein the optical fiber fixing device is made of a solid adhesive.

10. The installation assembly of claim 1, wherein the fixing member comprises:
a receiving chamber adapted to receive the optical fiber cable; and
fixing teeth formed in the receiving chamber and adapted to fix the optical fiber cable.

11. The installation assembly of claim 1, the guiding member further comprises:
a cover which covers the guiding member from outside and strengthens the locating of the fixing member in the guiding member, wherein the cover connects the fixing member and the guiding member having the optical fiber cable fixed therein to form a whole connector.

12. The installation assembly of claim 1, wherein the fixing member and the optical fiber connector are located at both ends of the guiding member respectively upon installation.

13. The installation assembly of claim 1, wherein the fixing member is detachably connected with the guiding member.

14. The installation assembly of claim 1, wherein the optical fiber connector connects the guiding member in manner of interference fitting.

15. The installation assembly of claim 1, wherein the splicing member is a disposable optical fiber splicing tool which can be discarded after one or more times of connection between the optical fiber cable and the optical fiber connector.

16. The installation assembly of claim 1, wherein the fixing member, the guiding member and the splicing member are made of plastic material.

17. A method for splicing optical fibers, comprising the steps of:
providing a fixing member and fixing an optical fiber cable in the fixing member;
providing a guiding member, and connecting an optical fiber connector and the fixing member having the optical fiber cable fixed therein to both ends of the guiding member respectively;
pushing the fixing member along the guiding member and putting a bare fiber of the optical fiber cable into the optical fiber connector until the optical fiber cable bends slightly so that the bare fiber of the optical fiber cable is in effective contact with an inline optical fiber in the optical fiber connector; and
providing a splicing member to press an optical fiber fixing device in the optical fiber connector and thus to fix the bare fiber within the optical fiber connector, so that an effective splicing between the bare fiber of the optical fiber cable and the inline optical fiber in the optical fiber connector is achieved.

18. The method for splicing optical fibers of claim 17, wherein lead-in amount of the bare fiber of the optical fiber cable in the optical fiber connector is adjusted through adjusting displacement of the fixing member relative to the guiding member by means of a fine tuning structure.

19. The method for splicing optical fibers of claim 17, wherein the bare fiber is in line with the inline optical fiber upon installation.

20. The method for splicing optical fibers of claim 17, wherein the optical fiber connector is connected to the guiding member in manner of interference fitting.

21. The method for splicing optical fibers of claim 17, wherein the splicing member is operated in manner of thread screwing.

22. The method for splicing optical fibers of claim 17, wherein after connecting the bare fiber and the inline optical fiber, a cover is provided to cover the guiding member from outside so as to strengthen the locating of the fixing member in the guiding member, wherein the cover connects the fixing member and the guiding member having the optical fiber cable fixed therein to form a whole connector.
